(19) United States
(12) Patent Application Publication
(10) Pub. No.: US 2013/0265745 A1
(43) Pub. Date: Oct. 10, 2013

(54) LIGHT INTEGRATED HARD HAT

(71) Applicant: TROY D. FISCHER, Gig Harbor, WA (US)

(72) Inventor: TROY D. FISCHER, Gig Harbor, WA (US)

(21) Appl. No.: 13/443,692

(22) Filed: Apr. 10, 2012

(51) Int. Cl. F21V 21/084

(52) U.S. Cl. 362/106

(57) ABSTRACT

A light integrated hard hat includes a protective head covering having a crown and a brim. A casing has an open window, whereby the casing is formed on a front portion of the crown and on the brim of the protective head covering. A first mechanism is for producing an illumination carried within the casing behind the open window. A second mechanism is for supplying electrical power to the illumination producing mechanism, so as to provide a projected focused beam through the open window of the casing.

### BACKGROUND OF THE INVENTION

1. Field of the Invention

The present invention relates to an illuminating protective helmet, and more particularly, a light integrated hard hat.

The light integrated hard hat is a protective helmet with an on/off switch, a battery bank and a front facing work light that's built into the protective helmet.

The present invention provides a hands-free integrated work light molded into the protective helmet and gives a user a hands free light source when working in low or no light conditions. The protective helmet is powered by a battery bank that is also molding into the protective helmet. The way the present invention works is that it is worn like a typical hard hat, but it has an on/off switch built in. When the switch is depressed once, it activates the integrated front facing headlight and turns it on. A second depression of the on/off switch turns the integrated headlight off.

2. Description of the Prior Art

Numerous innovations for illuminated head coverings have been provided in the prior art that will be described. Even though these innovations may be suitable for the specific individual purposes to which they address, however, they differ from the present invention.

A FIRST EXAMPLE, U.S. Pat. No. 5,688,039, Issued on Nov. 18, 1997, to Johnson teaches a safety helmet that has a battery operated, flashing rear light for wide angle visibility and a battery operated front light with a narrow projected forward beam to light the path being traversed. The front light pivots about a horizontal axis with manual control to adjust the attitude or inclination of the beam to enhance its utility.

A SECOND EXAMPLE, U.S. Pat. No. 5,810,467, Issued on Sep. 22, 1998, to Hurwitz teaches an illuminated protective hat that includes at least one electroluminescent lamp secured to a shell of the protective hat, which is powered by a power unit housed in a power unit portion of the protective hat shell, where the power unit includes a rechargeable battery. A retrofit unit includes at least one electroluminescent lamp and power unit portion, to retrofit existing protective hats with the electroluminescent lamp and power unit portion. Both the electroluminescent lamp and the power unit portion of the retrofit unit can be either permanently or temporarily secured to a protective hat.

A THIRD EXAMPLE, U.S. Patent Office Publication No. 2002/1086557, Published on Dec. 12, 2002, to Lary et al. teaches a common baseball-type hat or headband, to which is attached one or more arrays of light emitting diodes. It is the object of this invention to provide an efficient lighting apparatus which embodies the principles of an adjustable hat or headband worn on the head, to which a battery-powered light emitting diode apparatus is either permanently attached to the hat or headband, or removable attached to the hat or headband by a hook and loop concept.

A FOURTH EXAMPLE, U.S. Patent Office Publication No. 2005/0174753, Published on Aud. 11, 2005, to Cao et al. teaches a mining light having a semiconductor light source. The light may include a semiconductor light source such as an LED or laser, a heat sink, a magnetic switch, a light reflective and focusing cone, and other features.

A FIFTH EXAMPLE, U.S. Pat. No. 8,117,676, Issued on Feb. 21, 2012, to Cardoso teaches a hardhat which provides ventilation and controlled lighting. A crown of a modified semi-spherical shape terminates downwardly with a generally oval peripheral edge in a horizontal plane, the crown having a plurality of apertures therein arranged in spaced apart sequence, and a flexible venting strip fixed forwardly on the crown and extending over the apertures, the venting strip positionable in each of a plurality of arcs above the crown, wherein each one of the arcs provides a selectable ventilation conductance into the hardhat. A brim is joined integrally to the peripheral edge of the crown extending outwardly. An electrical circuit has components including: a head-lamp mounted forward on the hardhat, a series of individual lights mounted in spaced-apart positions circumventing the crown, and a manual control mounted on the brim, the manual control is enabled for setting the electrical circuit in a standard operating mode wherein the head-lamp and individual lights are activated, and in a distress operating mode wherein the individual lights are red in color and set to blinking, and in an emergency mode wherein a loudspeaker and radio distress beacon are activated.

It is apparent now that numerous innovations for illuminated head coverings have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a light integrated hard hat that avoids the disadvantages of the prior art.

ANOTHER OBJECT of the present invention is to provide a light integrated hard hat that is simple and inexpensive to manufacture.

STILL ANOTHER OBJECT of the present invention is to provide a light integrated hard hat that is simple to use.

BRIEFLY STATED, STILL YET ANOTHER OBJECT of the present invention is to provide a light integrated hard hat which includes a protective head covering having a crown and a brim. A casing has an open window, whereby the casing is formed on a front portion of the crown and on the brim of the protective head covering. A first mechanism is for producing an illumination carried within the casing behind the open window. A second mechanism is for supplying electrical power to the illumination producing mechanism, so as to provide a projected focused beam through the open window of the casing.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a front perspective view of the present invention in use;

FIG. 2 is a side cross sectional view taken along line 2-2 in FIG. 1;

FIG. 3 is a top cross sectional view taken along line 3-3 in FIG. 1;

FIG. 4 is an exploded front perspective view of the present invention illustrating the various components thereof;

FIG. 5 is a block diagram of the electrical components of the present invention; and

FIG. 6 is a schematic diagram of the electrical components.

### REFERENCE NUMERALS UTILIZED IN THE DRAWING

110 light integrated hard hat
112 protective head cover of hard hat 110
114 crown of covering 112
116 brim of covering 112
118 casing of hard hat 110
120 open window in casing 118
122 illumination producing mechanism of hard hat 110
124 electrical power supply mechanism of hard hat 110
126 safety helmet for covering 112
128 light assembly of mechanism 122
130 light emitting diode of light assembly 128
132 resistor of light assembly 128
134 battery of mechanism 124
136 control assembly of mechanism 124
138 on/off switch of control assembly 136
140 toggle type switch for switch 138

### DETAILED DESCRIPTION OF THE PREFERRED EMBODIMENT

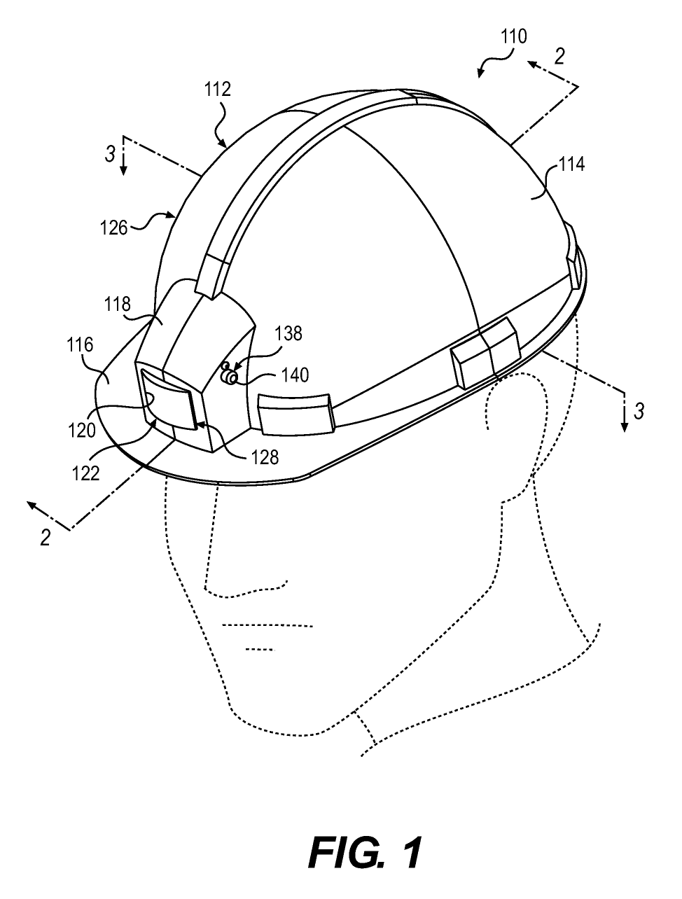

As shown in FIG. 1, the present invention is a light integrated hard hat 110 which includes a protective head covering 112 having a crown 114 and a brim 116. A casing 118 is formed on a front portion of the crown 114 and on the brim 116 of the protective head covering 112. The casing 118 has an open window 120. The casing 118 has a size about 2.5-3.0 inches (length), 1.0 inch (height) and 2.0-2.5 inches (width). The window 120 has a size about 2.5-2.0 inches (length), and 1.0-1.5 inches (width).

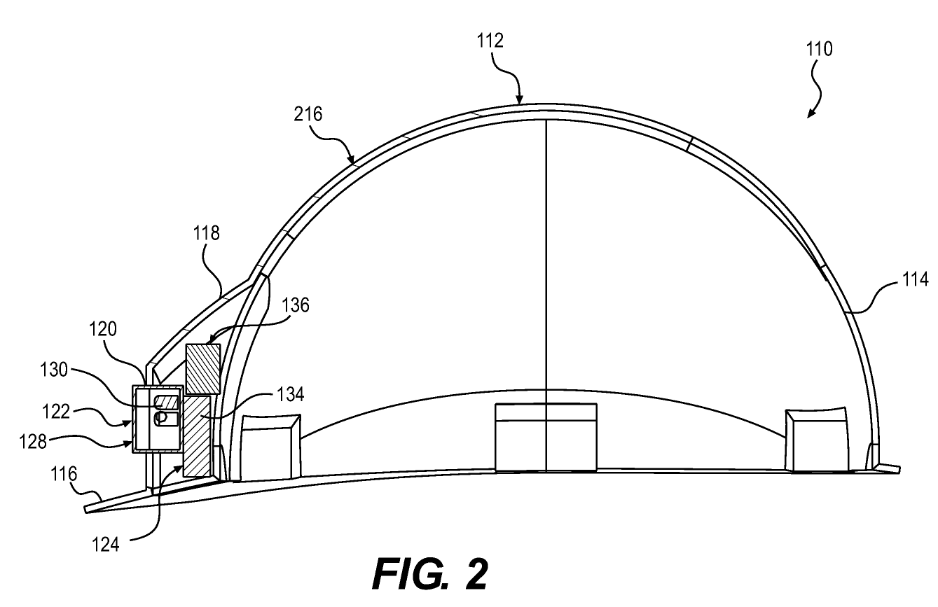

As shown in FIG. 2, a first mechanism 122 for producing an illumination is carried within the casing 118 behind the open window 120.

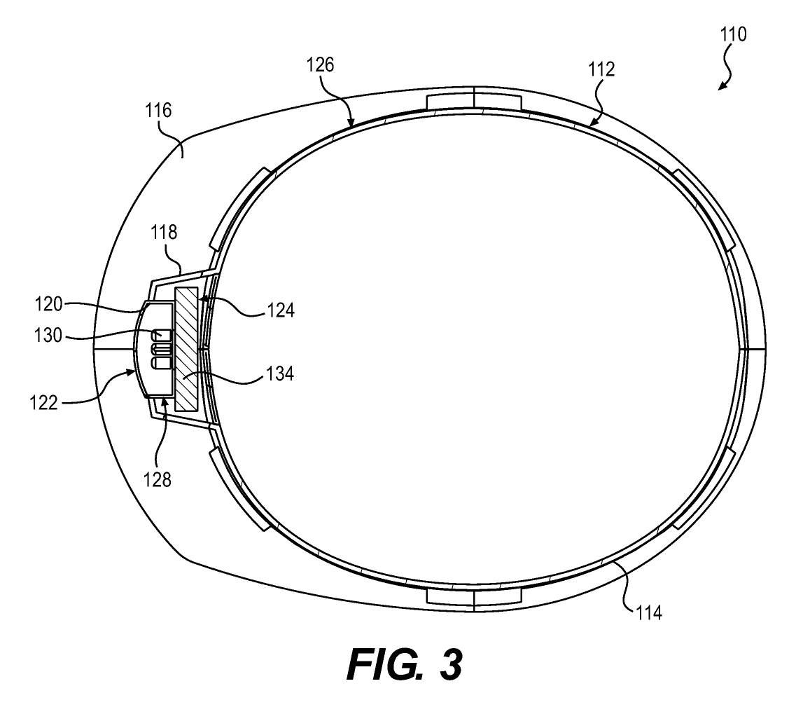

As shown in FIG. 3, a second mechanism 124 is for supplying electrical power to the illumination producing mechanism 122, so as to provide a projected focused beam through the open window 120 of the casing 118.

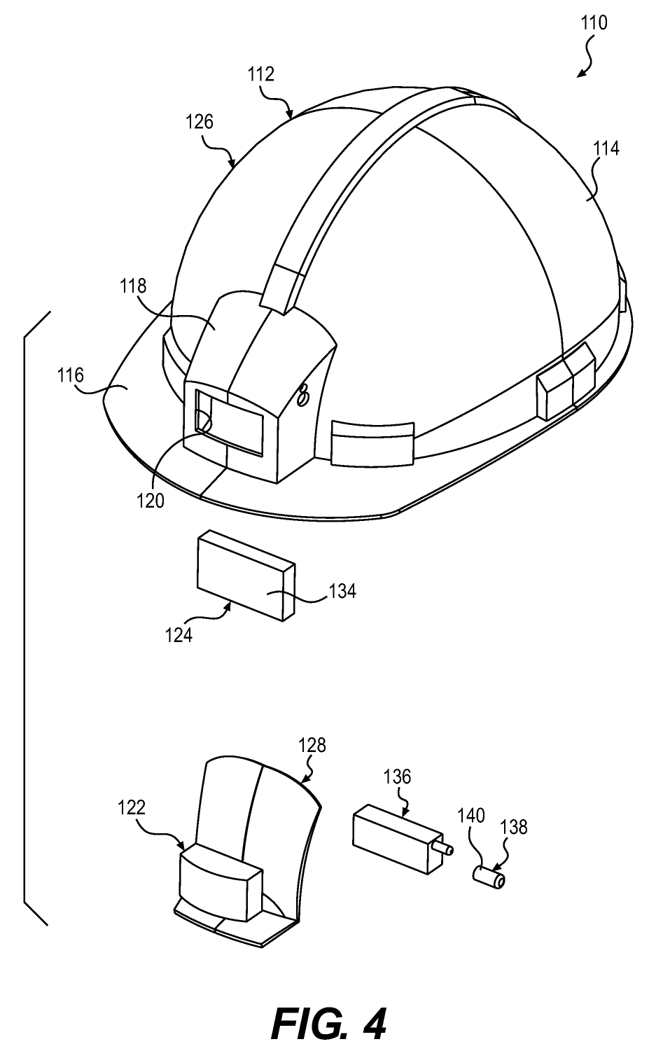

As shown in FIG. 4, the protective head covering 112 is a safety helmet 126. An illumination producing mechanism 122 includes a light assembly 128. A control assembly 136 includes an on/off switch 138 which extends through a side of the casing 118. The on/off switch 138 is a toggle type switch 140.

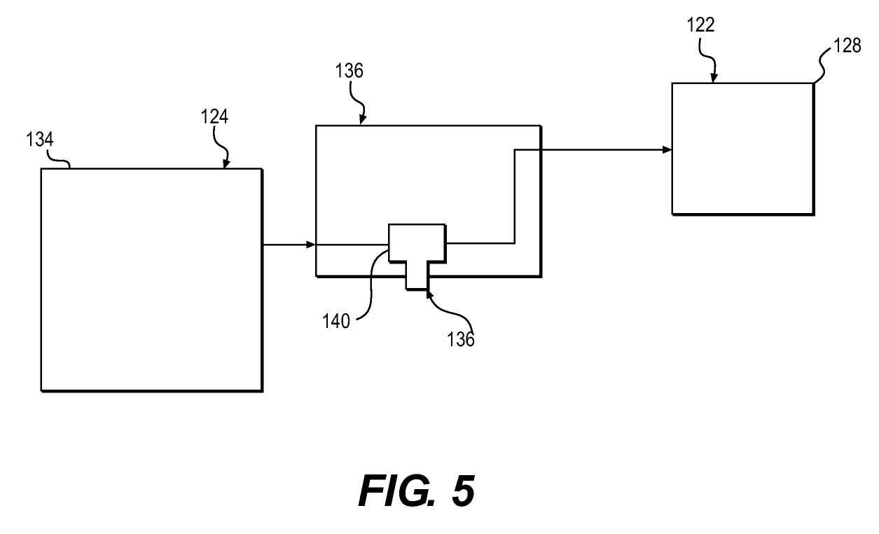

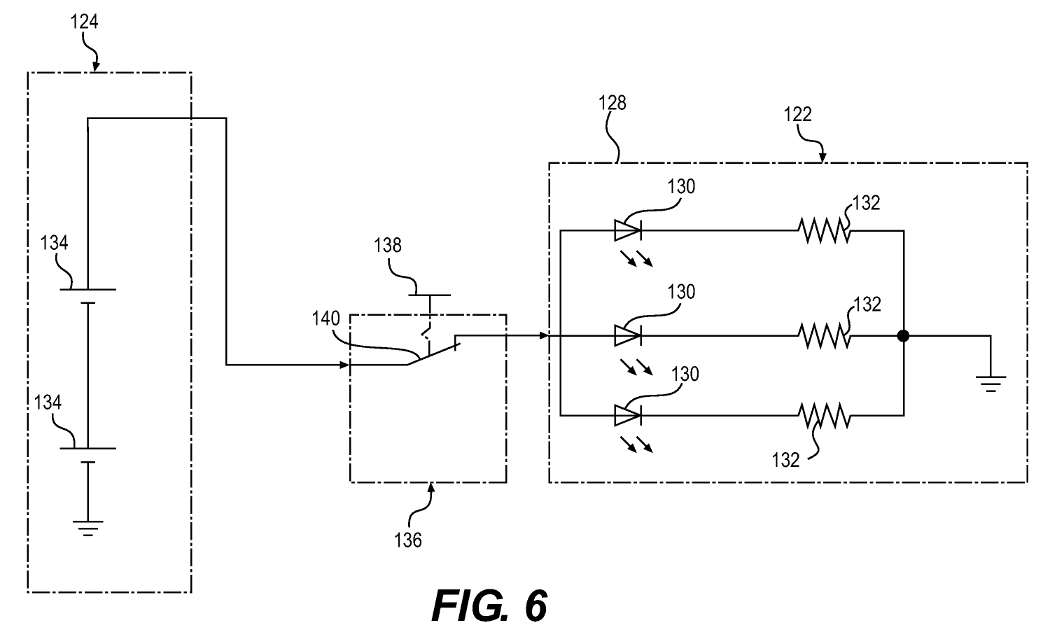

As shown in FIGS. 5 and 6, the illumination producing mechanism 122 includes alight assembly 128. The light assembly 128 includes three (03) parallel branches with three (03) light emitting diodes (LEDs) 130. In parallel configuration: If one LED is broken then the other two LEDs are still operating (for backing up each other).

The light assembly 128 further includes three limiting-current resistors 132 electrically connected in series with each one light emitting diode 130. The resistors 132 can be 1-1K ohms. The electrical power supplying mechanism 124 includes at least one battery bank 134 (+3V to +5V) carried within the same casing 118. The control assembly 136 includes an on/off switch 138 which extends through a side of the casing 118. The on/off switch 138 is a toggle type switch 140. The control assembly 136 (is carried within the casing 118) is electrically connected between the at least three light emitting diodes 130 and the at least one battery bank 134. The light emitting diodes LEDs 130 can be organic LEDs, white light LEDs or quantum dot LEDs.

The control assembly 136 includes an on/off switch 138 which extends through a side of the casing 118. The on/off switch 138 is a toggle type switch 140. The hard hat 110 has a size of 12.0 inch (length), 6.0 inch (height) and 9.3 inch (width).

It will be understood that each of the elements described above, or two or more together, may also find a useful application in other types of constructions differing from the types described above.

While the invention has been illustrated and described as embodiments of a light integrated hard hat, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A light integrated hard hat which comprises:
a) a protective head covering having a crown and a brim;
b) a casing having an open window, whereby the casing formed on a centered front portion of the crown and on the brim of the protective head covering;
c) means for producing an illumination carried within the casing behind the open window; and
d) means for supplying electrical power to the illumination producing means, so as to provide a projected focused beam through the open window of the casing.

2. The light integrated hard hat as recited in claim 1, wherein the protective head covering comprises a safety helmet.

3. The light integrated hard hat as recited in claim 1, wherein the illumination producing means comprises a light assembly.

4. The light integrated hard hat as recited in claim 3, wherein the light assembly comprises at least three light emitting diodes (LEDs) in parallel configuration.

5. The light integrated hard hat as recited in claim 4, wherein the light assembly further comprises one resistor electrically connected in series to each light emitting diode (LED).

6. The light integrated hard hat as recited in claim 5, wherein the electrical power supply means comprises at least one battery bank (+3 Volts to +5 Volts) carried within the same casing.

7. The light integrated hard hat as recited in claim 6, wherein the electrical power supply means further comprises a control assembly carried within the casing and electrically connected between the light emitting diodes and the battery bank.

8. The light integrated hard hat as recited in claim 7, wherein the control assembly comprises an on/off switch which extends through the side of the casing.

9. The light integrated hard hat as recited in claim 8, wherein the on/off switch is a toggle type switch.

10. The light integrated hard hat as recited in claim 4, wherein the light emitting diodes (LEDs) is selected from a group consisting of white, organic or quantum dot LEDs.

11. The light integrated hard hat as recited in claim 1, wherein the hard hat has a size of 12.0 inch (length), 6.0 inch (height) and 9.3 inch (width).

12. The light integrated hard hat as recited in claim 1, wherein the casing has a size about 2.5-3.0 inches (length), 1.0 inch (height) and 2.0-2.5 inches (width).
